(19) United States
(12) Patent Application Publication
(10) Pub. No.: US 2003/0025646 A1
(43) Pub. Date: Feb. 6, 2003

(54) Built-in test stimulation for antenna array

(76) Inventors: Kirby Chung, San Jose, CA (US); Michael Fashano, Canyon Lake, CA (US)

Correspondence Address: J.E. Kosinski, Loral Space & Communications, Ltd., 655 Deep Valley Drive, Suite 303, Rolling Hills Estates, CA, 90274, US

(21) Appl. No.: 09/920,920

(22) Filed: Aug. 2, 2001

(51) Int. Cl. H01Q 15/02; H01Q 1/38

(52) U.S. Cl. 343/909; 343/753; 343/700 MS

(57) ABSTRACT

The present invention is directed to, in a first aspect, an antenna array stimulation system. In one embodiment the system comprises an array of radiating elements, a conductive layer adjacent the array of radiating elements adapted to receive electrical energy from, or couple electrical energy to, the array, and at least one connection device adapted to couple the electrical energy between the conductive layer and a test unit, wherein antenna performance degradation due to potential losses in coupling the energy between the conductive layer and the test unit are minimized.

### BACKGROUND OF THE INVENTION

1. Field of the Invention

The present invention is generally related to antenna array systems and, more particularly, to a test system for an antenna array.

2. Brief Description of Related Developments

Antenna arrays are generally tested using source and reception devices that are located external to the antenna array. For example, the antenna array is placed on an antenna range and electrical and electromagnetic energy is transmitted to the array using a test source or received from the array. The test source is generally not part of the antenna system itself and can include its own antennas for radiating or receiving the test signals. This type of system does not allow for self-testing of the antenna array and tend to be large and cumbersome to use. A test range is generally a highly specialized and dedicated test facility.

### SUMMARY OF THE INVENTION

The present invention is directed to, in a first aspect, an antenna array stimulation system. In one embodiment the system comprises an array of radiating elements, a conductive layer adjacent the array of radiating elements adapted to receive electrical energy from, or couple electrical energy to, the array, and at least one connection device adapted to couple the electrical energy between the conductive layer and a test unit, wherein antenna performance degradation due to potential losses in coupling the energy between the conductive layer and the test unit are minimized.

In another aspect, the present invention is directed to a method of testing an antenna array. In one embodiment, the method comprises the steps of coupling a test signal from a test source to a conductive layer of the antenna. The conductive layer comprises a series of conducting elements, each conducting element having an individual connection point for receiving or transmitting the test signal from the test source. The output of the array responsive to the test signal is monitored to determine a performance level of the array.

In a further aspect, the present invention is directed to a built-in stimulator system for an antenna array. In one embodiment, the system comprises a polarizer device including a plurality of conductive elements arranged in a meandering pattern on the device. Each element is not electrically connected to another element. At least one impedance transformer electrically connected to each element and a coupler device adapted to electrically connect the impedance transformer to a test system and allow electrical signals to be passed between the polarizer and the test system.

### BRIEF DESCRIPTION OF THE DRAWINGS

The foregoing aspects and other features of the present invention are explained in the following description, taken in connection with the accompanying drawings, wherein:

FIG. 1 is an elevational view of a system incorporating features of the present invention.

FIG. 2 is an elevational view of an embodiment of a system incorporating features of the present invention using external transformers with a polarizer.

FIG. 3 is an elevational view of an embodiment of a system incorporating features of the present invention using integrated transformers with a polarizer.

FIG. 4 is an elevational view of an embodiment of a system incorporating features of the present invention using external transformers and a test coupler.

FIG. 5 is an elevational view of an embodiment of a system incorporating features of the present invention using integrated transformers with a test coupler.

### DETAILED DESCRIPTION OF THE PREFERRED EMBODIMENT

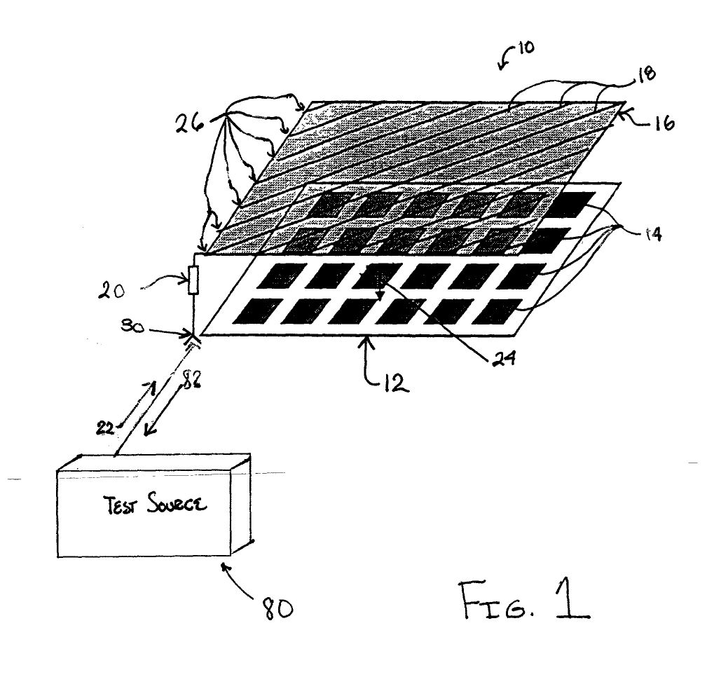

Referring to FIG. 1, there is shown an elevational view of a system 10 incorporating features of the present invention. Although the present invention will be described with reference to the embodiment shown in the drawings, it should be understood that the present invention can be embodied in many alternate forms of embodiments. In addition, any suitable size, shape or type of elements or materials could be used.

As shown in FIG. 1, the system 10 generally comprises an antenna array 12, a conducting layer or device 16 and a test signal connection device 20. The system 10 is generally adapted to couple electrical energy received or transmitted by the antenna array 12 to a test system 80 in order to test the behavior and performance of the antenna array 12. In an alternate embodiment the system 10 could include such other suitable components for built-in stimulation of an antenna array. It is a feature of the present invention to test polarized antenna arrays without the use of external radiating test equipment.

The antenna array 12 generally comprises an array or series of radiators 14, or smaller antennas. Generally any suitable antenna array 12 can be used and the user's design or application only limits the choice of antenna array.

The conducting layer or device 16 generally comprises a sheet of electrically conducting material that can be placed over the array 12 and is designed to work in conjunction with the array of radiators 14 to generate polarized energy in the direction to which the array 12 is pointed or oriented. The conducting layer 16 can include one or more elements or strips 18 of an electrically conductive material, such as for example, metal. The elements 18 can be positioned on, or embedded in, any suitable medium, such as for example, a dielectric material. In one embodiment, the conductive layer 16 can comprise a sheet of printed circuit material with thin strips of conductive elements 18 affixed thereon. In an alternative embodiment, the conductive layer 16 can be designed in any suitable manner that allows polarized energy to be radiated to or received from the direction to which the array 12 is pointed.

Referring to FIG. 1, the test connection device 20 generally comprises a mechanism or device adapted to couple or connect the conductive layer 16 to the test source 80. Although only one test connection device 20 is shown in FIG. 1, it will be understood by those of skill in the art that one or more test connection devices 20 can be used if the elements 18 are individual lines and are not electrically connected or coupled together or that the array of radiators 14 cannot be accessed by a single element 18. The test connection device 20 is generally adapted to couple a test signal 22 either being inputted into the elements 18 of the conducting layer 16 from the test source, or couple energy 82 coming from the conducting layer 16 in response to a radiated test signal 24 received by the array 12. In one embodiment, the test connection device 20 can comprise a impedance transformer that is adapted to convert the impedance that is useful for the test source or equipment. In an alternate embodiment, any suitable connection device can be used that allows a test signal 22 to be inputted to the conducting layer 16 from the test source 80, or allows electrical energy from a signal received by the conducting layer 16 to be transmitted back to the test source 80, shown as signal 82. It is a feature of the present invention to prevent or minimize antenna performance degradation due to the test connection 20 and related connections.

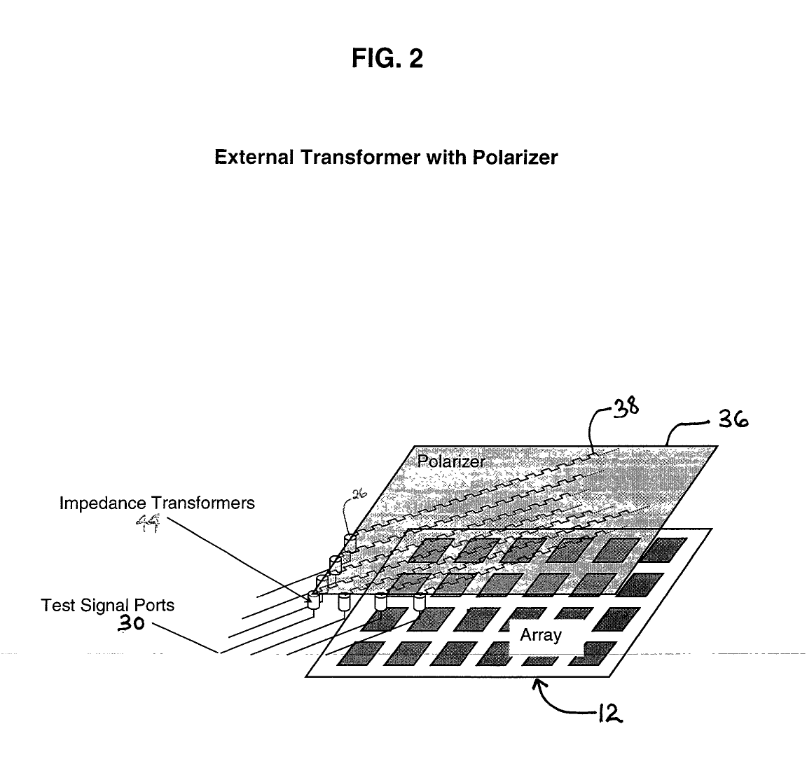

The system 10 can also include a test interface point 26 adapted to couple the test connection device 20 to one or more of the elements 18 of the conductive layer 16. In one embodiment, as shown in FIG. 1, the conducting layer 16 includes a test interface point 26 that couples or electrically connects each of the lines 18 together. In an alternate embodiment, as shown for example in FIG. 2, a separate test interface point 26 can be used for each line 18, resulting in a plurality of test interface points 26, where each element 18 is not coupled to another element 18. Generally, the test interface point 26 is chosen so as to maximize the number of signal pathways through the antenna array 14. In this fashion, each connection point 26 and corresponding line 18 can be energized individually or monitored to determine how well the array 12 is working.

A test signal connection port 30 can be used to couple the test source 80 to the test connection device 20. The test connection port 30 can comprise any suitable electrical connection device that can be used to couple an electrical signal from one point to another point with minimal loss and signal degradation.

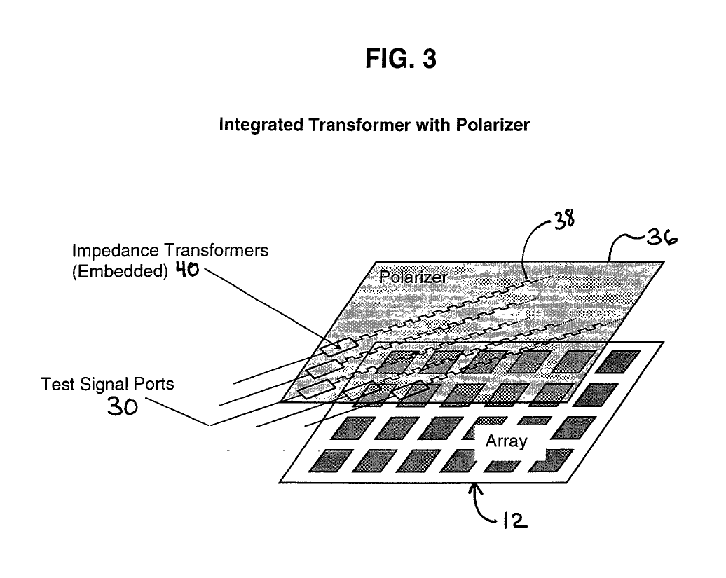

Referring to FIGS. 2 and 3, in one embodiment, the conducting layer 16 comprises a polarizer device 36. Preferably, the polarizer 36 comprises a meanderline polarizer with a series of rows of patterns of conductive elements 38. In one embodiment, the rows can run in a diagonal manner across the polarizer 36, but any suitable direction and pattern can be used. Generally, it is preferred that each conductive element 18 is not connected to another one of the elements 18 on the polarizer 36. Each element 18 can be a separate line. The polarizer 36 is generally designed and adapted so that it can be positioned adjacent to, or on top of, the array 12. If needed, a suitable distance between the array 12 and polarizer 36 can be incorporated into the design. The polarizer 36 should be positioned so that polarization of energy received from the array 12 or transmitted to the array 12 is achieved. In an alternate embodiment, any suitable polarizer can be used that can be located adjacent to or near the array 12 and manipulate the electromagnetic energy or signals received from the array 12 or electrical signals transmitted to the array 12. It is a feature of the present invention that the polarizer 36 be an inherent or permanent part of the system 10 design so that the array 12 can be tested in its final application and environment without the need for external stimulation equipment.

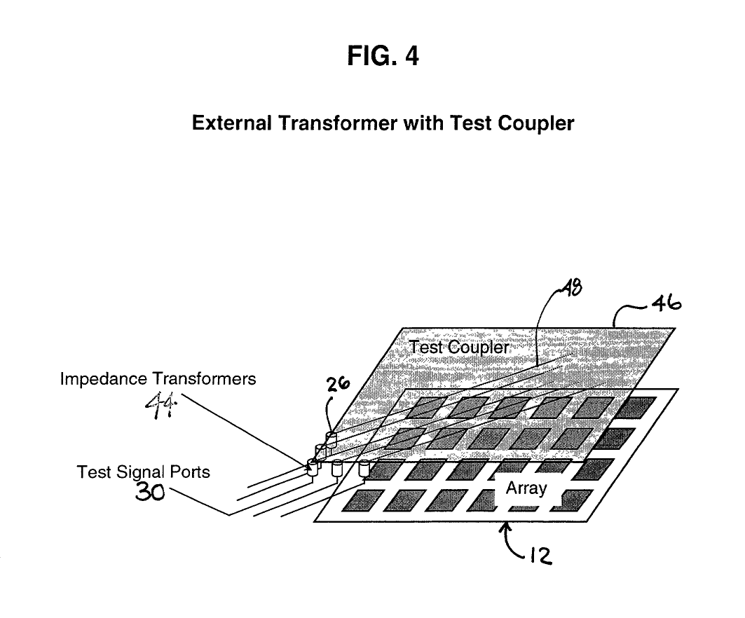

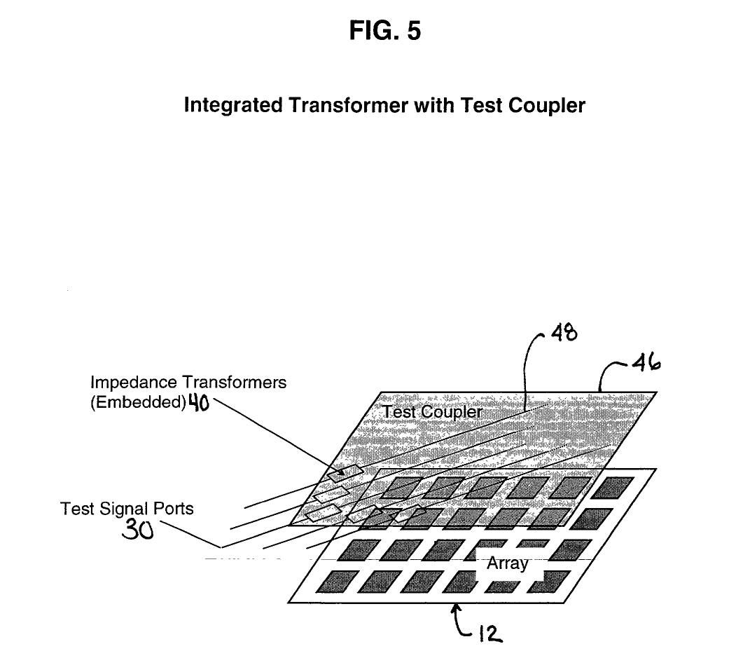

As shown in FIGS. 4 and 5, in an alternate embodiment, the conductive layer 16 can comprise a test coupler device 46. The test coupler device 46 can include a series of conductive metal strips 48 on, or embedded in, a dielectric material, for example. The test coupler device 46 is generally adapted to be removable from the array 12. Alternatively, the test coupler device is not removable. It is a feature of the present invention that the test coupler device is not used in the final application, but generally only for testing of the array prior to the final application and environment of the array. Although as shown in FIGS. 4 and 5, the elements 48 are shown as straight lines, it will be understood by those of skill in the art that any suitable pattern can be used, such as for example meandering lines, a zig zag pattern, or an alternating or high-low pattern.

Referring to FIGS. 2 and 4, in one embodiment, the test connection devices 20 include a plurality of impedance transformers 44 that are mounted or located external to the polarizer device 36 and test coupler device 32, respectively. In alternate embodiments, such as that shown for example in FIGS. 3 and 5, the test connection devices 20 can include impedance transformers 40 that are embedded in, or located internal to the polarizer device 36 or test coupler device 32, respectively.

In operation, the system 10 provides for built-in test (“BIT”) stimulation of the antenna array 12. The polarizer layer 36 is an inherent point of the design of the antenna array 12 and allows for the antenna and related equipment to be tested in-situ. Generally, a test signal 22, 24 is injected or coupled to the polarizer layer 36. A test source can be used to inject a test signal 22 into the polarizer 36 via the test signal port 30. Although one or more test signal ports can be used, single injection may be used depending on the array or sub-array 12 configuration to provide stimulation to all key elements 18 of the polarizer 36. Similarly, energy, or a radiated test signal 24, can be received by the array 12 and the polarizer 36 can receive electrical energy or radiation from the array 12. The energy coupled to the polarizer 36 can be transmitted back to the test source through the test signal ports 30 for evaluation. The system 10 can utilize an existing antenna design feature for generation of the test signal 22. This provides a built-in feature that is inherently part of the antenna design. In this manner, degradation of the antenna performance can be minimized.

The system 10 generally provides in-situ stimulation of an antenna array 12. Test performance and health measurements can be evaluated without the need for external radiating test equipment, such as for example, hats and probes. There is generally no degradation to polarizer performance. The system 10 can generally comprises a passive circuit, no bias, and does not need to contain any active devices. The system 10 can be mechanically rugged and safe to electrostatic discharge (“ESD”).

It should be understood that the foregoing description is only illustrative of the invention. Various alternatives and modifications can be devised by those skilled in the art without departing from the invention. Accordingly, the present invention is intended to embrace all such alternatives, modifications and variances that fall within the scope of the appended claims.

What is claimed is:

1. An antenna array stimulation system comprising:
an array of radiating elements;
a conductive layer adjacent the array of radiating elements adapted to receive electrical energy from, or couple electrical energy to, the array; and
at least one connection device adapted to couple the electrical energy between the conductive layer and a test unit, wherein antenna performance degradation due to potential losses in coupling the energy between the conductive layer and the test unit are minimized.

2. The system of claim 1 wherein the conductive layer comprises a polarizer.

3. The system of claim 1 wherein the conductive layer comprises a meanderline polarizer device.

4. The system of claim 1 wherein the conductive layer comprises an electrically conducting material arranged in spaced apart rows adapted to receive electrical energy from or transmit electrical energy to the antenna array.

5. The system of claim 1 wherein the conductive layer is a series of electrically conductive strips, each strip having its own connection device coupling a strip to the test unit.

6. The system of claim 1 wherein the connection device is an impedance transformer adapted to convert an impedance that is useful for the test device.

7. The system of claim 1 wherein the conductive layer is an inherent part of the antenna array.

8. A method of testing an antenna array comprising the steps of:
coupling a test signal from a test source to a conductive layer of the antenna, the conductive layer comprising a series of conducting elements, each conducting element having an individual connection point for receiving the test signal from the test source; and
monitoring an output of the array responsive to the test signal to determine a performance level of the array.

9. The method of claim 8 wherein each connection point is chosen to maximize a number of signal pathways through the antenna array.

10. A built-in stimulator for an antenna array comprising:
a polarizer device including a plurality of conductive elements arranged in a meandering pattern on the device, and wherein each element is not electrically connected to another element;
at least one impedance transformer, each impedance transformer being electrically connected to each element; and
a coupler device adapted to electrically connect the impedance transformer to a test system and allow electrical signals to be passed between the polarizer and the test system.

11. The system of claim 10 wherein each impedance transformer is embedded in the polarizer.

12. The system of claim 10 wherein each conductive element is electrically connected to the coupler device, and wherein electrical signals can pass from between each element and the coupler device in a selectable manner, wherein signals of different elements do not interfere with each other.

13. The system of claim 10 wherein the polarizer device is positioned in a permanent fashion adjacent to a direction in which the array is pointing and wherein polarization of energy received from the array or transmitted to the array is achieved.

14. The system of claim 10 wherein the polarizer device comprises a test coupler device that is adapted to be removable from the array.
